(19) United States
(12) Patent Application Publication
(10) Pub. No.: US 2025/0118990 A1
(43) Pub. Date: Apr. 10, 2025

(54) SYSTEMS AND METHODS FOR POWER DELIVERY SYSTEM TOPOLOGY-BASED INTERLOCKING

(71) Applicant: Schweitzer Engineering Laboratories, Inc., Pullman, WA (US)

(72) Inventor: Dale S. Finney, Little Bras D'or (CA)

(73) Assignee: Schweitzer Engineering Laboratories, Inc., Pullman, WA (US)

(21) Appl. No.: 18/483,032

(22) Filed: Oct. 9, 2023

(51) Int. Cl. H02J 13/00; H02J 3/00

(52) U.S. Cl. CPC H02J 13/00034; H02J 3/0012; H02J 13/00001; H02J 13/00002; H02J 2203/10

(57) ABSTRACT

An electric power system may include numerous devices electrically connected to numerous other devices. In some cases, it may be beneficial to quickly determine and resolve an electric power system topology. Using a protection and control (PAC) algorithm, an electric power delivery system may be identified and represented as a graph including nodes and edges. The nodes represent electric power sources, busses, and ground. The edges represent circuit breakers, disconnects switches, and ground switches. By representing the electric power delivery system as a graph, the connections between various nodes (e.g., power sources, busses, grounds) and edges (e.g., circuit breakers, disconnects, ground switches) may be quickly and easily realized, represented, and visualized. Doing so may reduce programming and testing time after a change to the topology.

### BACKGROUND

This disclosure relates to electric power delivery systems. More particularly, this disclosure relates to control systems of an electric power delivery system.

Electric power delivery and/or distribution systems deliver electric power to residential and commercial consumers. Protection and control schemes (sometimes referred to as PAC schemes) may need to adapt to a present circuit breaker or disconnect state (e.g., open or closed) for breakers with the electric power delivery system. Programmable logic may be used for such applications due to various topologies among the electric power delivery systems (e.g., substations). As the programmable logic may be user-configured, and the applications may be critical to maintaining the electric power delivery system, the programmable logic may undergo thorough testing, which may be rigorous, time consuming, and expensive. Each modification to the electric power delivery system (e.g., an addition or removal of a circuit) may entail retesting. Consequently, reprogramming and retesting the logic after a modification may be an arduous and costly process.

### BRIEF DESCRIPTION OF THE DRAWINGS

FIG. 1 is a schematic diagram of an embodiment of an electric power delivery system, in accordance with an aspect of the present disclosure;

FIG. 2 is a line diagram of a topology of a power system;

FIG. 3 is a graphical representation of a portion of the power system of FIG. 2 generated to effectuate a dynamic protection and control scheme, in accordance with an aspect of the present disclosure; and

FIG. 4 is a flowchart of a method for resolving the topology of the power system of FIG. 2 to generate the graphical representation of FIG. 3, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase “A or B” is intended to mean A, B, or both A and B.

Several aspects of the embodiments described may be implemented as software modules or components. As used herein, a software module or component may include any type of computer instruction or computer-executable code located within a memory device and/or transmitted as electronic signals over a system bus or wired or wireless network. A software module or component may, for instance, include physical or logical blocks of computer instructions, which may be organized as a routine, program, object, component, data structure, or the like, and which performs a task or implements a particular abstract data type.

An electric power system (e.g., a power delivery and/or distribution system) may include numerous devices (e.g., potential transformers, current transformers, and so on) electrically connected to numerous other devices. In some cases, it may be beneficial to quickly determine and resolve an electric power system topology.

Electric power delivery and/or distribution systems deliver electric power to residential and commercial consumers. Protection and control schemes (sometimes referred to as PAC schemes) may need to adapt to a present circuit breaker or disconnect state (e.g., open or closed) for breakers with the electric power delivery system. Programmable logic may be used for such applications due to various topologies among the electric power delivery systems (e.g., substations).

As the programmable logic may be user-configured, and the applications may be critical to maintaining the electric power delivery system, the programmable logic may undergo thorough testing, which may rigorous, time consuming, and expensive. Each modification to the electric power delivery system (e.g., an addition of a circuit) may necessitate retesting. Consequently, reprogramming and retesting the logic after a modification may be an arduous and costly process.

To reduce the programming and testing time for electric power delivery systems, a PAC algorithm such as a substation topology protection and control (STPAC) algorithm may be implemented in the electric power delivery systems. PAC algorithms may be implemented in centralized hardware such as a bus relay, a remote terminal unit (RTU), or a centralized protection and control system (CPC). However, a PAC algorithm may be implemented as a distributed algorithm for use in a power delivery system having discrete relays and using peer-to-peer messages that may be configured by the PAC algorithm.

An advantage of the PAC algorithm may be related to the IEC-61850 protocol. For example, the protocol identifies a logical node for interlocking called CILO. CILO may conventionally be implemented with user-programmed logic. This approach may be disadvantageous in certain instances as logical nodes may be mapped from a hardcoded control or protection function. Alternatively, an interlocking PAC algorithm may act as a CILO logical node.

Using the PAC algorithm, the electric power delivery system (e.g., substation) may be represented as a graph including nodes (e.g., points, vertices) and edges (e.g., arms or lines). The nodes represent electric power sources (e.g., line generators or transformers), busses, and ground. The edges represent circuit breakers, disconnects (disconnect switches), and ground switches. A substation may have a standard topology which is commonly found in the power system. The topology may also be unique to a particular substation. The PAC algorithms may be implemented in both standard or nonstandard topologies.

By representing the electric power delivery system as a graph, the connections between various nodes (e.g., power sources, busses, grounds) and edges (e.g., circuit breakers, disconnects, ground switches) may be quickly and easily realized, represented, and visualized. Quickly representing and visualizing these connections may reduce the time needed for programming and testing after a change to a power delivery system topology. For example, if a circuit or a device is added to or removed from the electric power delivery system, the PAC algorithm may instantaneously or near-instantaneously adjust a graph to reflect the new interconnections based on the updated topology.

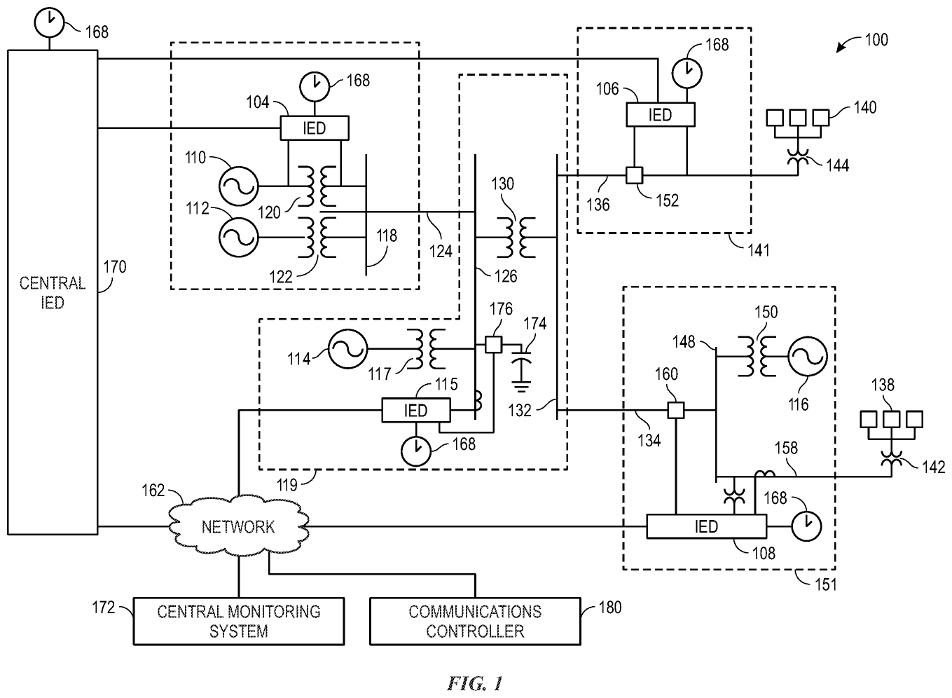

With the preceding in mind, FIG. 1 is a schematic diagram of an electric power delivery system 100 that may generate, transmit, and/or distribute electric energy to various loads (e.g., different structures). The electric power delivery system 100 may use various intelligent electronic devices (IEDs) 104, 106, 108, 115 to control certain aspects of the electric power delivery system 100. As used herein, an IED (e.g., the IEDs 104, 106, 108, 115) may refer to any processing-based device that monitors, controls, automates, and/or protects monitored equipment within the electric power delivery system 100. Although the present disclosure primarily discusses the IEDs 104, 106, 108, 115 as relays, such as a remote terminal unit, a differential relay, a distance relay, a directional relay, a feeder relay, an overcurrent relay, a voltage regulator control, a voltage relay, a breaker failure relay, a generator relay, and/or a motor relay, additional IEDs 104, 106, 108, 115 may include an automation controller, a bay controller, a meter, a recloser control, a communications processor, a computing platform, a programmable logic controller (PLC), a programmable automation controller, an input and output module, and the like. Moreover, the term IED may be used to describe an individual IED or a system including multiple IEDs.

For example, the electric power delivery system 100 may be monitored, controlled, automated, and/or protected using the IEDs 104, 106, 108, 115, and a central monitoring system 172 (e.g., an industrial control system). In general, the IEDs 104, 106, 108, 115 may be used for protection, control, automation, and/or monitoring of equipment in the electric power delivery system 100. For example, the IEDs 104, 106, 108, 115 may be used to monitor equipment of many types, including electric power lines, current sensors, busses, switches, circuit breakers, reclosers, transformers, autotransformers, tap changers, voltage regulators, capacitor banks, generators, motors, pumps, compressors, valves, and a variety of other suitable types of monitored equipment.

A common time signal may be distributed throughout the electric power delivery system 100. Utilizing a common time source may ensure that IEDs 104, 106, 108, 115 have a synchronized time signal that can be used to generate time synchronized data, such as synchrophasors. In various embodiments, the IEDs 104, 106, 108, 115 may receive a common time signal 168. The time signal may be distributed in the electric power delivery system 100 using a communications network 162 and/or using a common time source, such as a Global Navigation Satellite System (“GNSS”), or the like.

The IEDs 104, 106, 108, 115 may be used for controlling various other equipment of the electrical power delivery system 100. By way of example, the illustrated electric power delivery system 100 includes electric generators 110, 112, 114, 116 and power transformers 117, 120, 122, 130, 142, 144, 150. The electric power delivery system 100 may also include electric power lines 124, 134, 136, 158 and/or busses 118, 126, 132, 148 to transmit and/or deliver power, circuit breakers 152, 160, 176 to control flow of power in the electric power delivery system 100, and/or loads 138, 140 to receive the power in and/or from the electric power delivery system 100. A variety of other types of equipment may also be included in the electric power delivery system 100, such as a voltage regulator, a capacitor (e.g., a capacitor 174), a potential transformer (e.g., a potential transformer 182), a current sensor (e.g., a wireless current sensor (WCS) 184), an antenna (e.g., an antenna 186), a capacitor bank (e.g., a capacitor bank (CB) 188), and other suitable types of equipment useful in power generation, transmission, and/or distribution.

A substation 119 may include the electric generator 114, which may be a distributed generator and which may be connected to the bus 126 through the power transformer 117 (e.g., a step-up transformer). The bus 126 may be connected to the bus 132 (e.g., a distribution bus) via the power transformer 130 (e.g., a step-down transformer). Various electric power lines 136, 134 may be connected to the bus 132. The electric power line 136 may lead to a substation 141 in which the electric power line 136 is monitored and/or controlled using the IED 106, which may selectively open and close the circuit breaker 152. The load 140 may be fed from the electric power line 136, and the power transformer 144 (e.g., a step-down transformer) in communication with the bus 132 via electric power line 136 may be used to step down a voltage for consumption by the load 140.

The electric power line 134 may deliver electric power to the bus 148 of the substation 151. The bus 148 may also receive electric power from the distributed electric generator 116 via the power transformer 150. The electric power line 158 may deliver electric power from the bus 148 to the load 138 and may include the power transformer 142 (e.g., a step-down transformer). The circuit breaker 160 may be used to selectively connect the bus 148 to the electric power line 134. The IED 108 may be used to monitor and/or control the circuit breaker 160 as well as the electric power line 158.

According to various embodiments, the central monitoring system 172 may include one or more of a variety of types of systems. For example, the central monitoring system 172 may include a supervisory control and data acquisition (SCADA) system and/or a wide area control and situational awareness (WACSA) system. A central IED 170 (e.g., a switch) may be in communication with the IEDs 104, 106, 108, 115. The IEDs 104, 106, 108, 115 may be remote from the central IED 170 and may communicate over various media. For instance, the central IED 170 may be directly in communication with the IEDs 104, 106 and may be in communication with the IEDs 108, 115 via the communications network 162.

The central IED 170 may enable or block data flow between any of the IEDs 104, 106, 108, 115. For example, during operation of the electric power delivery system 100, the IEDs 104, 106, 108, 115 may transmit data with one another to perform various functionalities for the electric power delivery system 100 by initially transmitting the data to the central IED 170. The central IED 170 may receive the data and may subsequently transmit the data to an intended recipient of the data. The central IED 170 may also control data flow between one of the IEDs 104, 106, 108, 115 and another device communicatively coupled to the central IED 170, such as a computing device 178. For instance, the computing device 178 may be a laptop, a mobile phone, a desktop, a tablet, or another suitable device with which a user (e.g., a technician, an operator) may interact. As such, the user may utilize the computing device 178 to receive data, such as operating data, from the electric power delivery system 100 via the central IED 170 and/or to send data, such as a user input, to the electric power delivery system 100 via the central IED 170. Thus, the central IED 170 may enable or block operation of the electric power delivery system 100 via the computing device 178.

A communications controller 180 may interface with equipment in the communications network 162 to create a software-defined network that facilitates communication between the central IED 170, the IEDs 104, 106, 108, 115, and/or the central monitoring system 172. In various embodiments, the communications controller 180 may interface with a control plane (not shown) in the communications network 162. Using the control plane, the communications controller 180 may direct the flow of data within the communications network 162. Indeed, the communications controller 180 may communicate with the central IED 170 to instruct the central IED 170 to transmit certain data (e.g., data associated with a certain set of characteristics or information) to a particular destination (e.g., an intended recipient) using flows, matches, and actions defined by the communications controller 180.

As previously discussed, to reduce the programming and testing time for the electric power delivery system 100, a PAC algorithm such as a substation topology protection and control (STPAC) algorithm may be implemented in the electric power delivery system 100. PAC algorithms may be implemented in centralized hardware such as a bus relay, a remote terminal unit (RTU), or a centralized protection and control system (CPC). However, a PAC algorithm may be implemented as a distributed algorithm for use in a power delivery system having discrete relays and using peer-to-peer messages that may be configured by the PAC algorithm.

In some instances, a protocol identifies a logical node for interlocking (e.g., sometimes referred to as a control interlocking (CILO) node). Although these node may be defined with user-programmed logic, this approach may be disadvantageous in certain instances as logical nodes may be mapped from a hardcoded control or protection function. Instead, an interlocking PAC algorithm may act as a logical node.

Using the PAC algorithm, the electric power delivery system 100 may be represented as a graph including nodes (e.g., points, vertices) and edges (e.g., arms or lines). The nodes represent electric power sources (e.g., line generators or transformers), busses, and ground. The edges represent circuit breakers, disconnects, and ground switches. The state of an edge can may be defined by the physical position of a circuit breaker, disconnect switch, or ground switch using an auxiliary contact. It may also be defined by the flow of current through a circuit breaker. Both may be supported by the PAC algorithm. The PAC algorithms may be implemented in standard or nonstandard topologies.

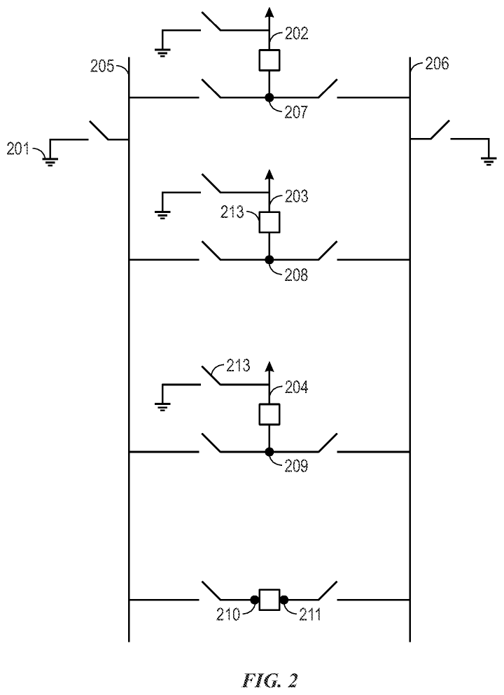

FIG. 2 is a line diagram of a topology of a power system 200. The power system 200 includes a ground 201, power sources (e.g., lines, generators, transformers) 202, 203, and 204, busses 205 and 206, electrical junctions 207, 208, 209, 210, and 211, and switches or circuit breakers 213. Each of these components may be defined (e.g., by a user) as nodes or edges. The grounds 201, sources 202, 203, and 204, and the busses 205 and 206 may be defined as nodes. Switches and circuitry breakers 213 may be defined as edges.

The PAC algorithm may be able to identify the various devices and the connections and paths between the various devices. For example, the PAC algorithm may determine that there is a switch between the ground 201 and the bus 205, or may determine that there are two switches between the ground 201 and the node 207. The PAC algorithm may generate a graph to illustrate the nodes, edges, and the connections between them to more easily and quickly determine interlocking capability. For example, a graphical illustration may enable the PAC algorithm to determine if one of the edges (e.g., a disconnect or a circuit breaker) is under load or if a certain action results in a circuit breaker or disconnect coupling a power source to ground, as will be discussed in greater detail with respect to FIG. 4 below.

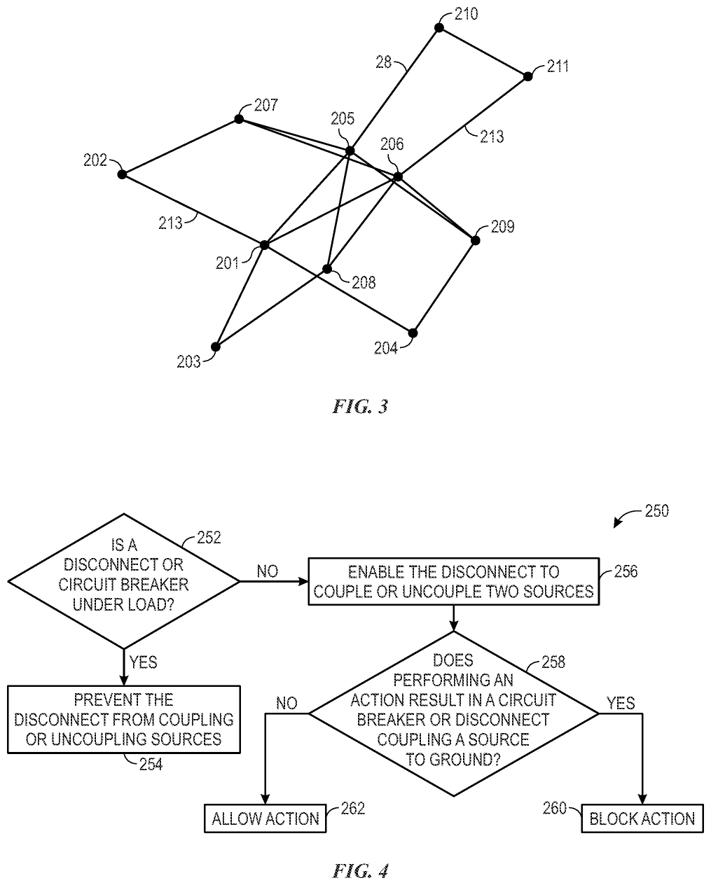

FIG. 3 is a graph 220 representing the power system 200 electric power delivery or distribution system, such as a substation or a portion of the electric power delivery system 100, according to embodiments of the present disclosure. In the graph 220, the ground 201, the power sources (e.g., line generators, transformers) 202, 203, and 204, the busses 205 and 206, and the electrical junctions 207, 208, 209, 210, and 211 are represented as graphical nodes, as may be observed from the graph 220. The circuit breakers, disconnects, and ground switches 213 may be represented as the edges (or lines) 213, as me be observed from the graph 220.

FIG. 4 is a flowchart of a method 250 for resolving an electric power system topology into a graph (e.g., the graph 200) via a PAC algorithm, according to an embodiment of the present disclosure. Any suitable device (e.g., a controller) that may control components of the electric power delivery system 100, such as the processor (e.g., of the IEDs 104, 106, 108, 115), may perform the method 250. In some embodiments, the method 250 may be implemented by executing instructions stored in a tangible, non-transitory, computer-readable medium, such as a memory, using the processor. For example, the method 250 may be performed at least in part by one or more software components, such as the control development software, one or more software applications of the IEDs 104, 106, 108, 115, and the like. While the method 250 is described using steps in a specific sequence, it should be understood that the present disclosure contemplates that the described steps may be performed in different sequences than the sequence illustrated, and certain described steps may be skipped or not performed altogether.

In process block 252, the processor may determine if a disconnect or circuit breaker is under load. If the processor determines that the disconnect or circuit breaker is under load (e.g., is receiving power), the processor, in process block 254, prevents the disconnect or circuit breaker from coupling or uncoupling two or more sources in the electric power system 200. If the processor prevents the disconnect or circuit breaker from coupling or uncoupling two or more sources, the processor may return to the process block 252 to determine again if the disconnect or the circuit breaker is under load. However, if the processor determines that the disconnect or circuit breaker is not under load (e.g., is not receiving power), the processor may, in process block 256, enable the disconnect or circuit breaker to couple or uncouple the sources 202, 203, or 204.

That is, a disconnect or circuit breaker cannot couple or uncouple two or more sources. To ensure that the disconnect or circuit breaker cannot couple or uncouple two or more sources under load, the PAC algorithm may check all disconnect switches in a power system (e.g., the power system 200) according to Equation 1 below:

$$Equation 1$$

$$D S {C}_{CtrlOK} ( n , m ) = length ( ( allpaths ( G , n , m ) ) ) > 1$$

$$OR {π}_{s} ( isempty ( allpaths ( G , n , S ) ) ) OR {π}_{s} ( isempty ( allpaths ( G , m , S ) ) )$$

Where, in Equation 1, G is the graph (e.g., the graph 220) representing the one-line, S is the set of the source nodes (e.g., 202, 203, and 204), and n and m represent the two nodes on either side of the disconnect or circuit breaker. Equation 1 may include three subexpressions that are logically ORed. Thus, if any of the three subexpressions is true, the disconnect switch may be operated. In the first subexpression, the allpaths function may return a set of all paths between n and m for graph G. The length function may check if there is at least one path in parallel with the disconnect switch. In the second subexpression, the allpaths function returns the set of all paths between n and the source S. The isempty function confirms that this set is empty and H takes the product over all sources. The result is true when there are no paths between n and any source S. The third subexpression repeats the operations of the second subexpression for node m. It should be noted that Equation 1 is merely one method for implementing the operation of the process block 252, and that alternative implementations using other graph functions are possible.

Returning to the method 250 of FIG. 4, in process block 258, the processor determines if performing an action (e.g., closing a disconnect switch, circuit breaker, or ground switch) causes a direct coupling between a source (e.g., 202, 203, or 204) to the ground (e.g., 201). If performing the action would cause a source to couple to ground, the processor may, in process block 260, block that action. However, if performing the action would not cause a source to couple to ground, the processor, in process block 262, would enable that action.

To ensure that the action does not result in a breaker or disconnect coupling a source to ground, the PAC algorithm may check all power and ground nodes in a power system (e.g., the power system 200) according to Equation 2 below:

$$Equation 2$$

$${BKR\_DSC}_{ClsNOK} \text{} ( n , \text{} m ) = [ {\sum }_{s} ( ( allpaths ( G , n , S ) ) ) > 1 AND ( ( allpaths ( G , m , GND ) > 1 ) ) ] OR [ {\sum }_{s} ( ( allpaths ( G , m , S ) ) ) > 1 AND ( ( allpaths ( G , n , GND ) > 1 ) ) ]$$

Where, in Equation 2, G is the graph representing the one-line (e.g., the graph 220), S is the set of source nodes, GND is the ground node, and n and m represent the two nodes on either side of the disconnect or circuit breaker that may couple the source to the ground node. In this manner, the method 250 may enable the PAC algorithm to control interlocking of the power system 200 based on the graph 220. It should be noted that the power system 200 and the graph 220 are merely examples, and do not limit the topologies that the PAC algorithm may operate on. Indeed, the dynamic nature of the PAC algorithm enables the PAC algorithm to work on any power system topology, such as standard and non-standard substation topologies.

In some embodiments, the graph 220 may be visualized on an electronic display. The graph 220 may be highlighted or color-coded to indicate whether the criteria discussed above are met or are violated. For example, if a disconnect switch or circuit breaker is under load, it may not be highlighted or color-coded as red, while if the disconnect switch or circuit breaker is not under load, the disconnect switch may be highlighted, or may be color coded as green. Similarly, a circuit breaker or disconnect that, when opened or closed, may couple a source to ground may not be highlighted or may be color coded as red, while a circuit breaker or disconnect that can be opened or closed without coupling a source to ground may be highlighted or color coded as green.

In some instances, interlocking schemes monitor the positions of circuit breakers and disconnect switches using auxiliary contacts connected to the breaker or disconnect physical mechanism. A bad status indication occurs when the auxiliary contact fails or there is an open or short circuit of the secondary wiring, or the monitoring hardware fails. In some cases, it may be beneficial to monitor two contacts, one that is closed when the device (e.g., the circuit breaker, the disconnect switch, the ground switch) is closed and one that is closed when the device is opened. If both are closed or both are opened, then the status is declared bad. Another practice compares the auxiliary contact status with the presence of electrical current. One response to a bad status is to suspend interlocking checks. However, based on the characteristics of the PAC algorithm (e.g., that the PAC algorithm looks at the status of all devices in the power system 200), suspending interlocking checks may disable interlocking checks for the entirety of the power system 200, rather than only impacting a portion of the total number of devices in the power system 200.

However, some of the statuses used in a status check may be redundant. For example, in a path between a source node and a ground node, there may be several devices in series, and if any of the devices is opened then the path is open. Similarly, there may be several parallel paths connecting the two sides of a device, and any may be closed to maintain a connection across the device. These redundancies may be utilized to increase the scheme availability. To leverage redundant status checks, Equation 1 and Equation 2 may be performed twice-once with the bad status forced to “opened,” and again with the bad status forced to “closed.” If there is no difference in the outcome between the two checks, then the status is redundant for that particular check.

While specific embodiments and applications of the disclosure have been illustrated and described, it is to be noted that the disclosure is not limited to the precise configurations and devices disclosed herein. For example, the systems and methods described herein may be applied to an industrial electric power delivery system or an electric power delivery system implemented in a boat or oil platform that may or may not include long-distance transmission of high-voltage power. Accordingly, many changes may be made to the details of the above-described embodiments without departing from the underlying principles of this disclosure. The scope of the present disclosure should, therefore, be determined only by the following claims.

Indeed, the embodiments set forth in the present disclosure may be susceptible to various modifications and alternative forms, specific embodiments have been shown by way of example in the drawings and have been described in detail herein. However, it may be noted that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f).

What is claimed is:

1. A method comprising:
receiving a representation of a topology of a power delivery system;
generating a graph representing interconnection between devices in the power delivery system;
determining whether a first disconnect switch in the power delivery system is receiving a current;
in response to determining that the disconnect switch is not receiving a current, determining whether performing an action results in a second disconnect switch coupling a power source to ground; and
in response to determining that performing the action will not result in the second disconnect switch coupling the power source to ground, enabling the action.

2. The method of claim 1, wherein generating the graph comprises representing power sources, busses, and ground terminals as nodes in the graph.

3. The method of claim 2, wherein generating the graph comprises representing circuit breakers, disconnects, and ground switches as connections between the nodes in the graph.

4. The method of claim 1, comprising determining a change to the topology of the power delivery system and dynamically adjusting the graph to reflect the change to the topology.

5. The method of claim 4, wherein determining the change to the topology comprises determining that a circuit component was added to the power delivery system.

6. The method of claim 4, wherein determining the change to the topology comprises determining that a circuit component was removed from the power delivery system.

7. The method of claim 1, wherein generating the graph comprises displaying a visual representation of the graph on an electronic display.

8. The method of claim 7, comprising highlighting or color-coding the visual representation based on determining whether the first disconnect switch in the power delivery system is receiving the current.

9. The method of claim 8, comprising highlighting or color-coding the first disconnect switch green in response to determining that the first disconnect switch is not receiving the current.

10. The method of claim 8, comprising color-coding the first disconnect switch red in response to determining that the first disconnect switch is receiving the current.

11. A power delivery system, comprising:
a plurality of disconnect switches;
a plurality of power sources;
a remote terminal unit, the remote terminal unit comprising a processor configured to:
determine a topology of a power delivery system;
generate a graph representing interconnection between devices in the power delivery system;
determine whether a first disconnect switch of the plurality of disconnect switches in the power delivery system is receiving a current;
in response to determining that the first disconnect switch is not receiving a current, determine whether performing an action results in a second disconnect switch of the plurality of disconnect switches coupling a power source to ground; and
in response to determining that performing the action will not result in the second disconnect switch coupling the power source to ground, enable the action.

12. The electric power system of claim 11, wherein the processor is configured to generate a graph comprising nodes and edges coupling the nodes, wherein the nodes represent power sources, busses, or ground terminals and the edges comprise circuit breakers, disconnect switches, and ground switches.

13. The electric power system of claim 11, wherein the processor is configured to provide the graph to an electronic display for visualization.

14. The electric power system of claim 11, wherein the processor is configured to highlight or color code the visualization based on whether performing the action will result in the second disconnect switch coupling the power source of the plurality of power sources to ground.

15. The electric power system of claim 14, wherein the processor is configured to highlight or color code the second disconnect switch green based on determining that the action will not result in the second disconnect switch coupling the power source to ground.

16. The electric power delivery system of claim 14, wherein the processor is configured to remove a highlight or color code the second disconnect switch red based on determining that the action will result in the second disconnect switch coupling the power source to ground.

17. The electric power delivery system of claim 11, wherein the action comprises closing the second disconnect switch.

18. A tangible, non-transitory, computer-readable medium comprising machine-readable instructions configured to cause a processor to:
generate a graph representing interconnection between devices in the power delivery system;
determine whether a first circuit breaker in the power delivery system is receiving a current;
in response to determining that the first circuit breaker is not receiving a current, determine whether closing a second circuit breaker results in the second circuit breaker coupling a power source to ground; and
in response to determining that closing the second circuit breaker will result in the second circuit breaker coupling the power source to ground, blocking the second circuit breaker from closing.

19. The tangible, non-transitory, computer-readable medium of claim 18, wherein the instruction are configured to cause the processor to determine that a third circuit breaker is associated with a faulty status.

20. The tangible, non-transitory, computer-readable medium of claim 18, wherein the instruction are configured to cause the processor to:
force the faulty status to “open” and determine whether the first circuit breaker in the power delivery system is receiving a current and determine whether closing the second circuit breaker results in the second circuit breaker coupling a power source to ground;
force the faulty status to “closed” and determine whether the first circuit breaker in the power delivery system is receiving a current and determine whether closing the second circuit breaker results in the second circuit breaker coupling a power source to ground; and
based on determining that there is not difference between forcing the faulty status to “open” or “closed”, determining that the faulty status is redundant.
